(19) United States
(12) Patent Application Publication
(10) Pub. No.: US 2025/0257761 A1
(43) Pub. Date: Aug. 14, 2025

(54) BRAKE ASSEMBLY WITH SPLIT TYPE RACE

(71) Applicant: HL MANDO CORPORATION, Gyeonggi-do (KR)

(72) Inventors: Kwangseok HONG, Auburn, MI (US); Connor STARK, Auburn, MI (US); Mason HECK, Auburn, MI (US); Matthew BOHN, Auburn, MI (US)

(21) Appl. No.: 19/051,082

(22) Filed: Feb. 11, 2025

Related U.S. Application Data
(60) Provisional application No. 63/553,577, filed on Feb. 14, 2024.

(51) Int. Cl. F16C 19/06; B60T 13/74; F16D 55/226; F16D 65/00; F16D 125/40; F16D 125/44; F16D 125/48

(52) U.S. Cl. CPC F16C 19/06; F16D 65/005; B60T 13/746; F16C 2326/01; F16D 55/226; F16D 2125/40; F16D 2125/44; F16D 2125/48

(57) ABSTRACT

A brake assembly comprises a rotatable part configured to be rotatable by an actuator and a translatable part operably coupled with the rotatable part and configured to be axially translatable relative to the rotatable part to move the brake pad according to rotation of the rotatable part; and a bearing assembly configured to support the rotatable part. The bearing assembly comprises: an inner race comprising a forward inner race portion and an aft inner race portion; an outer race; and rollable balls. The forward inner race portion located closer to the brake pad than the aft inner race portion is made of a different and/or stronger material from and/or than the aft inner race portion located farther from the brake pad than the forward inner race portion, and/or is smaller than the forward inner race portion located farther from the brake pad than the aft inner race portion.

### CROSS REFERENCE TO RELATED APPLICATIONS

This application claims the benefit from and the priority to U.S. Patent Application Ser. No. 63/553,577, filed on Feb. 14, 2024 entitled “FOUR-POINT BALL BEARING STRUCTURE FOR EMB SYSYEM”, which is hereby incorporated herein by reference in its entirety.

### BACKGROUND

Various embodiments of the present disclosure generally relate to brake assemblies for a vehicle and more particularly to a brake assembly having a bearing assembly with a split type race.

An electro-mechanical brake (EMB) is a brake assembly that is actuated by electrical energy. For example, the EMB system generally provides braking of a vehicle by the use of a motor which becomes selectively energized in response to a signal of an electronic control unit (ECU) or a sensed depression of a brake input means. Generally, the EMB system may include a rotor, a brake caliper, and brake pads on opposing sides of the rotor. The brake caliper is slideably supported on pins secured to an anchor bracket fixed to a non-rotatable component of the vehicle, and includes one or more piston bores, each of which houses a piston that is movable along a piston axis during a brake apply and release of the brake apply. The brake pads are connected to one or more electrically actuated pistons for movement between a non-braking position and a braking position where the brake pads are moved into frictional engagement with the opposed braking surfaces of the rotor. For example, when an operator of the vehicle depresses a brake pedal, an actuator can move the piston into contact with one brake pad and then move one brake pad into contact with one side of the rotor, while another opposing brake pad is moved into contact with an opposing side of the rotor.

By way of example and without limitation, such an EMB system provides the desired braking in a substantially shorter amount of time than that which is provided by a conventional hydraulic braking system and allows each of the individual wheels of a vehicle or other selectively movable assembly to be selectively controlled, thereby enhancing the effectiveness of many operating strategies such as an anti-skid or anti-lock braking strategy or a strategy which is commonly referred to as an integrated vehicular dynamic strategy.

### SUMMARY

The features and advantages of the present disclosure will be more readily understood and apparent from the following detailed description, which should be read in conjunction with the accompanying drawings, and from the claims which are appended to the end of the detailed description.

According to some embodiments of the present disclosure, a brake assembly may comprise: a rotatable part configured to be rotatable by an actuator: a translatable part operably coupled with the rotatable part, the translatable part configured to be axially translatable relative to the rotatable part to move a brake pad according to rotation of the rotatable part; and a bearing assembly configured to support the rotatable part, the bearing assembly comprising: an inner race comprising a forward inner race portion and an aft inner race portion; an outer race; and rollable bodies rollably disposed between the inner race and the outer race.

The forward inner race portion located closer to the brake pad than the aft inner race portion may have a different material from the aft inner race portion located farther from the brake pad than the forward inner race portion; an outer race.

The rotatable part may have a protrusion outwardly protruding toward the bearing assembly to form the forward inner race portion located closer to the brake pad than the aft inner race portion such that the forward inner race portion of the inner race is integrally formed on an outside of the rotatable part as a single piece, and the aft inner race portion located farther from the brake pad than the forward inner race portion may be attached to the outside of the rotatable part.

The forward inner race portion located closer to the brake pad than the aft inner race portion and the aft inner race portion located farther from the brake pad than the forward inner race portion may be shaped asymmetrically to each other.

The aft inner race portion located farther from the brake pad than the forward inner race portion may be smaller than the forward inner race portion located closer to the brake pad than the aft inner race portion.

A clearance between the rollable bodies and the aft inner race portion located farther from the brake pad than the forward inner race portion may be greater than a clearance between the rollable bodies and the forward inner race portion located closer to the brake pad than the aft inner race portion.

The aft inner race portion located farther from the brake pad than the forward inner race portion may have more clearance to the rollable bodies than the outer race and the forward inner race portion located closer to the brake pad than the aft inner race portion.

A part of the forward inner race portion located closer to the brake pad than the aft inner race portion may be located in a plane passing through centers of the rollable bodies such that a boundary or gap between the forward inner race portion and the aft inner race portion is offset from the plane passing through the centers of the rollable bodies.

A weight of the aft inner race portion located farther from the brake pad than the forward inner race portion may be lighter than a weight of the forward inner race portion located closer to the brake pad than the aft inner race portion.

A strength of the aft inner race portion located farther from the brake pad than the forward inner race portion may be lower than a strength of the forward inner race portion located closer to the brake pad than the aft inner race portion.

An internal radius of curvature of an inner surface of the forward inner race portion, located closer to the brake pad than the aft inner race portion, facing the rollable bodies may be shorter than an internal radius of curvature of an inner surface of the aft inner race portion, located farther from the brake pad than the forward inner race portion, facing the rollable bodies.

A center point of an internal radius of curvature of an inner surface of the forward inner race portion, located closer to the brake pad than the aft inner race portion, facing the rollable bodies may be offset from a center point of an internal radius of curvature of an inner surface of the aft inner race portion, located farther from the brake pad than the forward inner race portion, facing the rollable bodies.

An inner surface of the forward inner race portion, located closer to the brake pad than the aft inner race portion, facing the rollable bodies may be curved, and an inner surface of the aft inner race portion, located farther from the brake pad than the forward inner race portion, facing the rollable bodies may be flat.

The brake assembly may further comprise a retainer configured to support the aft inner race portion, located farther from the brake pad than the forward inner race portion, to limit movement of the aft inner race portion in an axial direction of the rotation part.

The retainer may extend between a gear or pulley provided on the rotatable body and one side of the aft inner race portion located farther from the brake pad than the forward inner race portion such that the retainer supported by the gear provided on the rotatable body supports the aft inner race portion.

The brake assembly may further comprise a gear or pulley provided on the rotatable body and supporting one side of the aft inner race portion located farther from the brake pad than the forward inner race portion to retain the aft inner race portion the bearing assembly

The aft inner race portion located farther from the brake pad than the forward inner race portion may be press-fitted on the rotatable body.

According to certain embodiments of the present disclosure, a brake assembly may comprise: a brake pad configured to be movable toward or away from a rotor; a nut-screw mechanism configured to move the brake pad, the nut-screw mechanism including a nut part configured to be rotatable and a screw part operably coupled with the nut part and configured to be axially translatable relative to the nut part to move the brake pad according to rotation of the nut part; and a bearing assembly configured to support the nut part, the bearing assembly comprising: an inner race comprising a forward inner race portion and an aft inner race portion; an outer race; and rollable bodies rollably disposed between the inner race and the outer race.

The forward inner race portion located closer to the brake pad than the aft inner race portion may have a different material from the aft inner race portion located farther from the brake pad than the forward inner race portion.

A strength of the aft inner race portion located farther from the brake pad than the forward inner race portion may be lower in strength of the forward inner race portion located closer to the brake pad than the aft inner race portion.

The aft inner race portion located farther from the brake pad than the forward inner race portion may be smaller than the forward inner race portion located closer to the brake pad than the aft inner race portion.

The nut part may have a protrusion outwardly protruding toward the bearing assembly to form the forward inner race portion located closer to the brake pad than the aft inner race portion such that the forward inner race portion of the inner race is integrally formed on an outside of the nut part as a single piece, and the aft inner race portion located farther from the brake pad than the forward inner race portion may be attached to the outside of the nut part.

The forward inner race portion located closer to the brake pad than the aft inner race portion and the aft inner race portion located farther from the brake pad than the forward inner race portion may be shaped asymmetrically to each other.

The aft inner race portion located farther from the brake pad than the forward inner race portion may be smaller than the forward inner race portion located closer to the brake pad than the aft inner race portion.

A clearance between the rollable bodies and the aft inner race portion located farther from the brake pad than the forward inner race portion may be greater than a clearance between the rollable bodies and the forward inner race portion located closer to the brake pad than the aft inner race portion.

A part of the forward inner race portion located closer to the brake pad than the aft inner race portion may be located in a plane passing through centers of the rollable bodies such that a boundary or gap between the forward inner race portion and the aft inner race portion is offset from the plane passing through the centers of the rollable bodies.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 is a schematic cross-sectional view of an electro-mechanical brake system according to an embodiment of the present disclosure;

FIG. 2 is an enlarged view of a bearing assembly taken from a portion A in FIG. 1 according to an embodiment of the present disclosure;

FIG. 3 is an enlarged view of a bearing assembly taken from a portion B in FIG. 2 according to an embodiment of the present disclosure;

FIG. 4 is an enlarged view of a bearing assembly taken from a portion A in FIG. 1 according to another embodiment of the present disclosure;

FIG. 5A shows a pure axial load path generated in a brake assembly during actuation of an actuator assembly according to an embodiment of the present disclosure;

FIG. 5B illustrates a pure radial load path generated in a brake assembly during actuation of an actuator assembly according to an embodiment of the present disclosure;

FIG. 5C shows a load path of combination of an axial load and a radial load generated in a bearing assembly included in a brake assembly according to an embodiment of the present disclosure;

FIG. 6A to 6C show a process of assembling a bearing assembly and a rotatable part of a nut-screw mechanism; and

FIG. 7 illustrates a partial cross-sectional view of an electro-mechanical brake system according to another embodiment of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

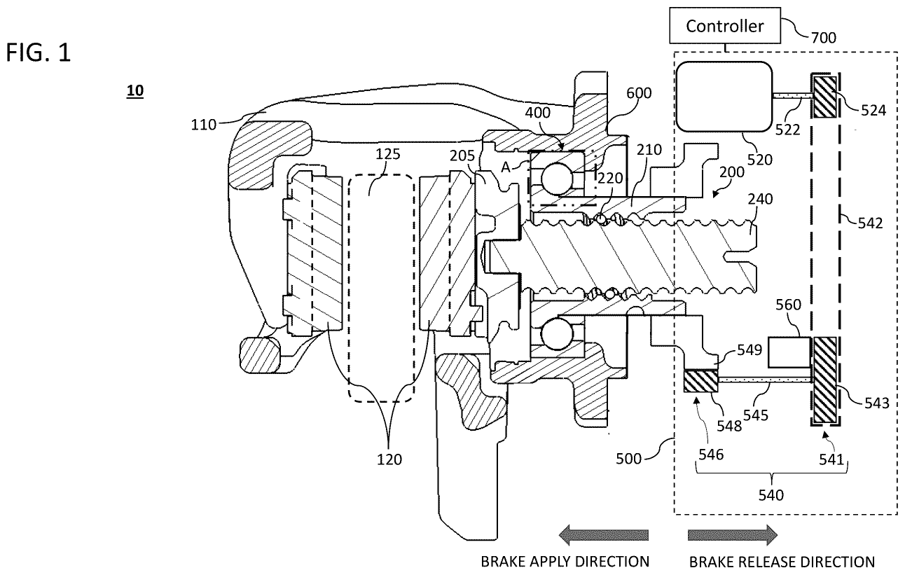

FIG. 1 is a schematic cross-sectional view of an electro-mechanical brake system according to an embodiment of the present disclosure.

Referring to FIG. 1, an electro-mechanical brake (EMB) system 10 may include a brake caliper 110 mounted in a floating manner by means of a brake carrier. When a vehicle is in motion, a brake rotor 125 may rotate with a wheel about an axle of the vehicle. Brake pad assemblies (or brake lining assemblies) 120 are provided in the brake caliper 110. The brake caliper 110 may include a bridge with fingers, and the fingers of the brake caliper 110 may be in contact with the brake pad assemblies 120. The brake pad assembly 120 is disposed with a small air clearance on a side of the brake rotor 125, such as a brake disc, in a release position so that no significant residual drag moment occurs.

The electro-mechanical brake system 10 may comprise a drive mechanism 200 (such as a nut-screw mechanism and a ball nut-screw mechanism) configured to convert rotary motion generated by an actuator assembly 500 into linear motion in order to move the brake pad assembly 120 toward or away from the brake rotor 125 in an axial direction. The drive mechanism 200 may include a rotatable part 210 and a translatable part 240. For example, the rotatable part 210 may comprise a nut or a ball nut and the translatable part 240 may comprise a screw or a ball screw, although not required. The nut-screw mechanism 200 may be contained within a housing 600. The rotatable part 210 and the translatable part 240 may be concentrically mounted in a cavity formed by an inner wall of the housing 600. The housing 600 may be fixedly coupled with the brake caliper 110. The rotatable part 210 is operably coupled to the actuator assembly 500, and is configured to be rotatable by the actuation of the actuator assembly 500.

The actuator assembly 500 may comprises an electric motor 520. For example, the electric motor 520 may be directly engaged with the rotatably part 210 of the drive mechanism 200. Alternatively, as shown in FIG. 1, the electric motor 520 may be indirectly connected to the rotatably part 210 through means for transferring rotary force generated by the electric motor 520, such as one or more gears, one or more belts, one or more pulleys, any other connecting means and combination thereof.

The actuator assembly 500 may have a multi-stage drive mechanism 540, although not required. The multi-stage drive mechanism 540 may be implemented as, for example, but not limited to, a dual-stage drive mechanism comprising a belt drive mechanism 541 and a gear drive mechanism 546 to multiply torque from the electric motor 520 to supply rotary force to the rotatable body 210 of the drive mechanism 200. The belt drive mechanism 541 multiplies the torque from the electric motor 520 by using a motor shaft 522, a drive pully 524 and a driven pulley 543 rotatably connected by a drive belt 542, and the torque multiplied by the belt drive mechanism 541 is delivered to the gear drive mechanism 546 through an intermediate shaft 545. The intermediate shaft 545 may connect the driven pulley 543 of the belt drive mechanism 541 to a first gear 548 of the gear drive mechanism 546 in order to deliver rotary torque, generated by the motor 520 and transmitted through the belt drive mechanism 541, to the gear drive mechanism 546. The first gear 548 is rotatably engaged with the second gear 549 to rotate the second gear 549 by the rotary torque transmitted through the intermediate shaft 545. The second gear 549 may be formed directly on a part of the circumferential surface of the rotatable body or nut 210 of the drive mechanism or screw-nut mechanism 200, or be mounted to the rotatable body 210 of the drive mechanism 200 to rotate the rotatable body or nut 210.

A controller 700 may be configured to control the actuator assembly 500 and a parking lock mechanism 560 configured to lock the movement of a component of the electro-mechanical brake 10 such as a gear, a pulley, a shaft, a nut, and the like by being mechanically interlocked with at least one of components of the electro-mechanical brake system 10. For example, in a parking lock state, the strut or pin of the parking lock mechanism 560 may be inserted into one of teeth formed on one surface of the driven pulley 543 facing the parking lock mechanism 560. The controller 700 controls the electric motor 520 to perform a service brake operation and a parking brake operation such as application or release of a service brake and a parking brake. The controller 700 may be, for example, but not limited to, a micro-controller unit (MCU), a circuit chip, a semiconductor circuit, and a circuit board having memory, one or more processors, and electric components. Further, the controller 700 may be configured to communicate with other controllers such as a central electronic control unit (ECU). Therefore, according to the control of the controller 700, the actuator assembly 500 can provide rotary torque to the nut-screw mechanism 200 to move the brake pad assembly 120 in the brake apply direction or the brake release direction.

The actuator assembly 500 rotates the rotatable part 210 of the nut-screw mechanism 200, and then the nut-screw mechanism 200 converts the rotary motion of the rotatable part 210 to the linear motion of the translatable part 240 to move the brake pad assembly 120 between its brake apply and release positions. For example, the actuation of the actuator 500 causes the rotatable part 210 to rotate, and the rotation of the rotatable part 210 causes the translatable part 240 to be linearly moved. Specifically, the rotatable part 210 can rotate relative to the housing 600, and the rotation of the rotatable part 210 relative to the housing 600 causes to the translatable part 240 advance or retract axially depending on a direction of rotation of the rotatable part 210. As the rotatable part 210 rotates in an expanding direction, the translatable part 240 linearly translates with respect to the rotatable part 210 and the housing 600 so that the translatable part 240 can translate out from the rotatable part 210 and the housing 600 towards the brake rotor 125. As the rotatable part 210 rotates in a collapsing direction, the translatable part 240 linearly translates with respect to the rotatable part 210 and the housing 600 so that the translatable part 240 can linearly move toward the rotatable part 210 and the housing 600 in a direction away from the brake rotor 125. The brake pad footing 205 is fixedly coupled to the translatable part 240 so that the brake pad footing 205 can be linearly movable together with the translatable part 240. When the nut-screw mechanism 200 is in the expanded state, the brake pad footing 205 pushes the brake pad assembly 120 toward the brake rotor 125. When the ball-screw mechanism 200 is in the collapsed state, the brake pad footing 205 moves away from the brake rotor 125.

While the expanding or collapsing direction depends upon whether the nut or ball nut of the rotatable part 210 and the screw or ball screw of the translatable part 240 are left-handed or right-handed, a specific direction is not critical to some embodiments of the present disclosure, and most embodiments of the present disclosure can work with either.

The rotatable part 210 may have a tubular shape with axially open ends, and the translatable part 240 is received within an inside space of the rotatable part 210. The rotatable part 210 and the translatable part 240 are operably connected to each other such that while the rotatable part 210 rotates, the translatable part 240 is linearly movable relative to the rotatable part 210. In other words, the translatable part 240 is slidable with respect to the rotatable part 210, but the translatable part 240 cannot be rotatable relative to the rotatable part 210, and therefore as the rotatable part 210 rotates, the translatable part 240 is linearly moved. For example, the translatable part 240 has a structure configured to prevent the translatable part 240 from rotating relative to the rotatable part 210 while allowing the translatable part 240 to translate in the axial direction.

At least a part of the translatable part 240 is retained within the rotatable part 210. The rotatable part 210 has an internally-threaded track groove and the translatable part 240 has an externally-threaded track groove for a rollable body arrangement of rollable bodies 220 (e.g. balls). The rollable bodies 220 are disposed between the internally-threaded track groove of the rotatable part 210 and the externally-threaded track groove of the translatable part 240. Ball returns either internally or externally carry the rollable bodies 220 from the end of their path back to the beginning to complete their recirculating track. A return tube can perform recirculation of the rollable bodies 220. The internally-threaded track groove of the rotatable part 210 and the externally-threaded track groove of the translatable part 240 form a series of ball tracks to provide a helical raceway for reception of a train of recirculating the rollable bodies 220. The rollable bodies 220 may be metal spheres which decrease friction and transfer loads between adjacent components. The rotatable part 210 is rotatably supported by the translatable part 240 via the rollable bodies 220 and a bearing assembly 400. However, in alternative embodiments of the present disclosure, the rotatable part 210 and the translatable part 240 can be directly engaged with each other without the rollable bodies 220.

The bearing assembly 400 is configured to rotatably support the drive mechanism 200 such as a nut-screw mechanism. The bearing assembly 400 may be positioned between the rotatable part 210 of the drive mechanism 200 and a non-rotating structure, for example, but not limited to, the housing 600. The bearing assembly 400 is used to rotatably support the rotatable part 210 for rotation relative to a non-rotating structure of the brake assembly 10.

The bearing assembly 400 may have an inner race 410, an outer race (or an outer ring) 420, a plurality of rollable bodies 430 (e.g., bearing balls), and a bearing cage 440. The bearing assembly 400 may include any number of rollable bodies 430, for example, more than two balls. The outer race 420 may be located concentrically about the inner race 410, with the rollable bodies 430 therebetween, in a plane generally perpendicular to a rotatable axis of the rotatable part 210 or the inner race 410 or a translatable axis of the translatable part 240. The inner race 410 is rotatable, but the outer race 420 is substantially non-rotatable.

The rollable bodies 430 are configured to aid in rotation of the inner race 410, formed on and/or coupled to the rotatable part 210, relative to the outer race (or the outer ring) 420. The rollable bodies 430 are disposed in an annular cavity, defined by the inner race 410 and the outer race 420, between the inner race 410 and the outer race 420. The rollable bodies 430 are supported within the bearing cage 440 such that the rollable bodies 430 are appropriately circumferentially spaced and retained by the bearing cage 440. The bearing cage 440 is disposed between the inner race 410 and the outer race 420. In an exemplary embodiment, the rollable bodies 430 may be spherical in shape, for example, but not limited to, balls.

The inner race 410 defines an inner circumferential surface of the bearing assembly 400, and is provided on the outside of the rotatable part 210 (e.g. a ball nut of the ball-screw mechanism 200).

In an embodiment of the present disclosure, the inner race 410 has a split race configuration such that the inner race 410 includes a forward inner race portion 411 and an aft inner race portion 412. The forward inner race portion 411 is located closer to the brake pad assembly 120 than the aft inner race portion 412. The aft inner race portion 412 is located farther from the brake pad assembly 120 than the forward inner race portion 411.

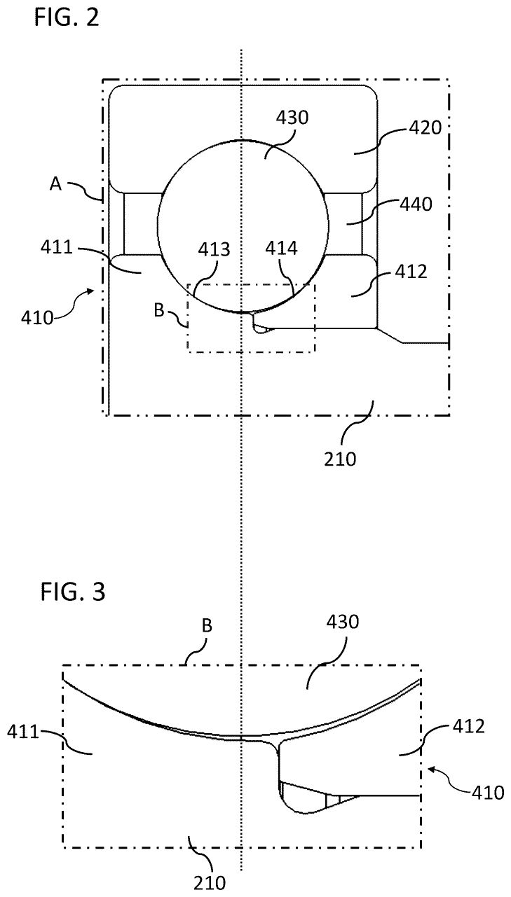

The forward inner race portion 411 positioned closer to the brake pad assembly 120 may be directly formed on the outer surface of the rotatable part 210 of the nut-screw mechanism 200. For example, as illustrated in FIGS. 1 and 2, a portion of the outer surface of the rotatable part 210 defines the forward inner race portion 411. More specifically, the rotatable part 210 has a protrusion outwardly projecting toward the bearing assembly 400 to form the forward inner race portion 411. Therefore, the forward inner race portion 411 can be integrated with the rotatable part 210 as one single piece, thereby providing a simpler assembly process and reducing manufacturing cost. Alternatively, the forward inner race portion 411 may be coupled to the outer surface of the rotatable 210 as a separate piece.

The aft inner race portion 412 positioned farther from the brake pad assembly 120 may be fixedly attached to the rotatable part 210. For instance, the aft inner race portion 412 may be coupled to the outer surface of the rotatable part 210 by press-fit or heat drop.

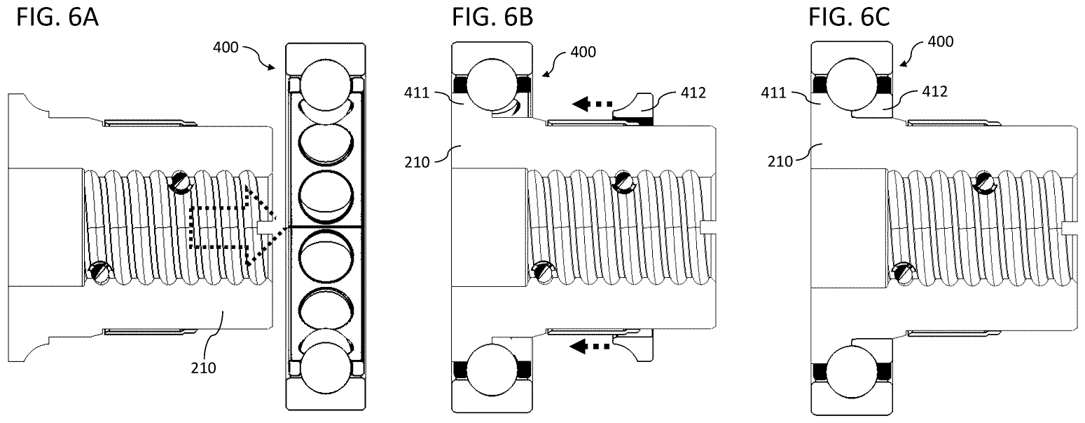

During the assembly of the bearing assembly 400, as illustrated in FIG. 6A the rotatable part 210 of the drive mechanism 200 on which the forward inner race portion 411 is formed is inserted into the center of the outer ring 420 to which the rollable bodies 430 are assembled, and as illustrated in FIGS. 6B and 6C the aft inner race portion 412 is inserted to the bearing assembly 400 to be coupled to the rotatable part 210 of the drive mechanism 200.

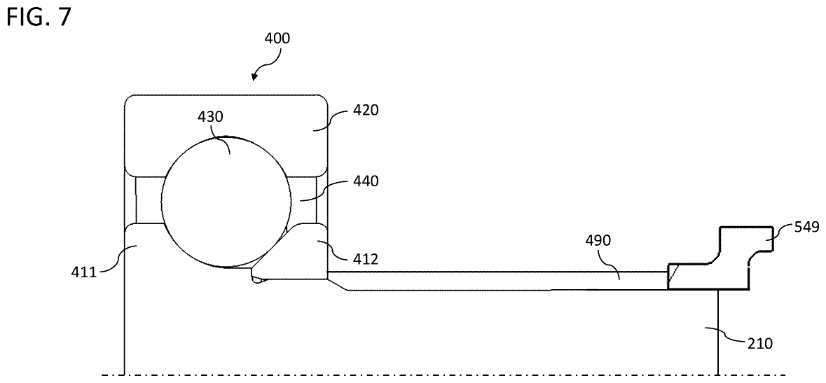

Alternatively, the aft inner race portion 412 may be fixed in place on the outside of the rotatable part 210 using a retainer 490. The retainer 490 may be utilized as a stopper for the aft inner race portion 412. As illustrated in FIG. 7, the retainer 490 may be supported by the second gear 549 attached to the rotatable part 210 such that the retainer 490 can limit the axial movement of the aft inner race portion 412 and the aft inner race portion 412 can be securely fixed in position by being supported by the retainer 490. As another example, a groove may be formed on the outer surface of the rotatable part 210 around one side of the aft inner race portion 412, and the retainer 490 such as a snap-type ring (e.g. a generally C-shaped retaining ring) may be removably seated within the groove of the rotatable part 210 so that the retainer 490 can support one side of the aft inner race portion 412 or provide an axial stop for the aft inner race portion 412. Alternatively, a part of a gear or pulley (e.g. the second gear 549) provided on the outer surface of the rotatable part 210 can extend to the aft inner race portion 412 to support one side of the aft inner race portion 412 such that the part of a gear or pulley provided on the outer surface of the rotatable part 210 can function as a stopper instead of including the retainer 490 as a separate piece. For instance, the retainer 490 may be integrated into the gear or pulley provided on the outer surface of the rotatable part 210.

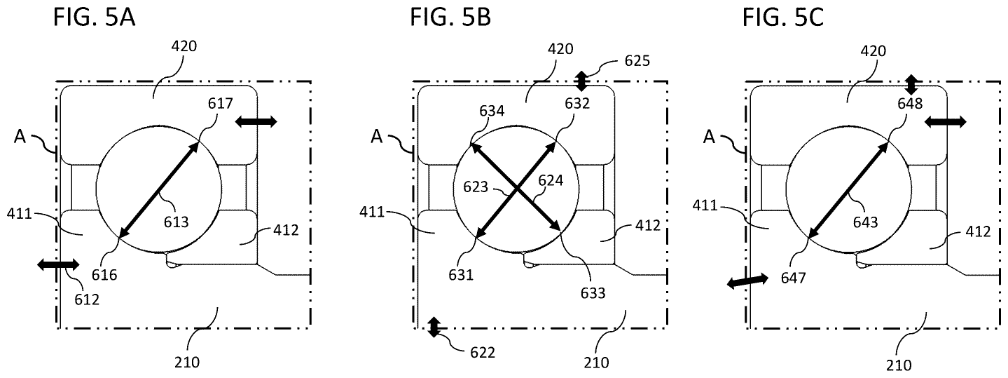

In FIG. 5A showing a pure axial load path in the brake assembly 10 according to an embodiment of the present disclosure, the actuation of the actuator assembly 500 generates a compression load on the translatable part 230 (e.g. a ball screw). The compression load on the translatable part 230 can be transmitted to the rotatable part 210 through the rollable bodies 430. A first action arrow 612 shows an axial load which is caused by a force transferred to the rotatable part 210 (e.g. a ball nut) via the rollable bodies 261 (e.g. internal ball nut/screw balls). Then, the force transferred to the rotatable part 210 acts on the bearing assembly 400. The force transferred through the bearing assembly 400 creates a load supporting line 613, thereby forming two contact points per rollable body 430 because the inner race 410 and the outer race 420 move in opposite axial directions relative to each other. One contact point 616 per rollable body 430 is formed on the forward inner race portion 411, and another contact point 617 per rollable body 430 is formed on the outer race 420. Accordingly, among the forward inner race portion 411 and the aft inner race portion 412 included in the inner race 410, one contact point per rollable body 430 is formed at the forward inner race portion 411 only. The force on the bearing assembly 400 is transferred to a part of the housing 600. A second action arrow 614 illustrates a force transferred from the outer race 232 of the bearing assembly 230 to a part of the housing 600 (e.g. an EMB bridge) in an axial direction.

In FIG. 5B showing a pure radial load path in the brake assembly 10 according to an embodiment of the present disclosure, the actuation of the actuator assembly 500 places a relatively small radial load on the translatable part 230 (e.g. a ball screw). The radial load on the translatable part 230 can be transmitted to the rotatable part 210 through the rollable bodies 430. A first action arrow 622 shows a radial load which is caused by a force transferred to the rotatable part 210 (e.g. a ball nut) via the rollable bodies 430 (e.g. internal ball nut/screw balls). Then, the force transferred to the rotatable part 210 acts on the bearing assembly 400. A force transferred through the bearing assembly 400 creates two load supporting lines 623, 624, thereby forming four contact points per rollable body 430 since the inner race 410 and the outer race 420 radially move toward each other. The first load supporting line 623 can form a first contact point 631 on the forward inner race portion 411, and a second contact point 632 on a portion of the outer race 420. The second load supporting line 624 can form a third contact point 633 on the aft inner race portion 412, and a fourth contact point 634 on the outer race 420. Therefore, two contact points are formed at each of the inner race 410 and the outer race 420 per rollable body 430. The force on the bearing assembly 400 is transferred to a part of the housing 600. A second action line 625 illustrates a force transferred from the outer race 420 of the bearing assembly 400 to a part of the housing 600 (e.g. an EMB bridge) in a radial direction.

FIG. 5C shows a load path of combination of the axial load and the radial load generated in the brake assembly 10 according to an embodiment of the present disclosure. As illustrated in FIGS. 6A and 6B, a relatively large axial load vector is generated by the actuation of the actuator assembly 500 during the brake apply, while a radial load vector relatively much smaller than the axial load vector is generated. The deflection of the brake caliper 110 during a braking event may be the source of the radial load. The combination of the large axial load vector and the small radial load vector can create one load supporting line 643 forming two contact points 647 and 648 per rollable body 430 in the bearing assembly 400. One contact point 647 of the combination load is formed on the forward inner race portion 411 while no contact point is formed on the aft inner race portion 412, and another contact point 648 is formed on the outer race 420. Accordingly, the forward inner race portion 411 can act as a high load-bearing inner race portion on which loads are applied, while the aft inner race portion 412 can act as a non-load-bearing inner race portion during a braking event. Among the forward inner race portion 411 and the aft inner race portion 412 included in the inner race 410, the forward inner race portion 411 on which a contact point per rollable body 430 is formed endures high axial loads. Unlike the forward inner race portion 411, the aft inner race portion 412 does not need to endure the load generated during the brake operation of the brake assembly 10, and can function only for retaining the rollable bodies 430 and preventing the disassembly of the bearing assembly 400.

Therefore, according to some embodiments of the present disclosure, the forward inner race portion 411 and the aft inner race portion 412 of the inner race 410 may be made of different materials and have different shapes, respectively, and/or be configured differently from each other.

Because no or relatively small load is applied to the aft inner race portion 412 during the brake operation of the brake assembly 10 and the aft inner race portion 412 only performs the function of retaining the rollable bodies 430 and preventing the disassembly of the bearing assembly 400, the aft inner race portion 412 may have less material than the forward inner race portion 411, and the aft inner race portion 412 may be made of a material of lower strength and/or less weight than the forward inner race portion 411.

Low-cost material, for example, but not limited to, such as steel without heat treatment, aluminum, plastic, and the like can be used for the aft inner race portion 412 without affecting the performance of the bearing assembly 400 during the brake operation of the brake assembly 10, thereby reducing the cost for manufacturing the bearing assembly 400.

In addition, by making the aft inner race portion 412 lighter in weight, the overall weight of the bearing assembly 420 can be lowered without affecting the capability of the inner race 410 which can endure the load generated during the braking operation of the brake assembly 10.

The forward inner race portion 411 and the aft inner race portion 412 may have a different shape from each other. The forward inner race portion 411 and the aft inner race portion 412 may be asymmetrical about an axis of the rollable body 430.

For example, the aft inner race portion 412 may be smaller than the forward inner race portion 411. The reduction in the size of the aft inner race portion 412 may not affect the function of the bearing assembly 400 which supports the load generated when the brake operation of the brake assembly 10 is being performed. Accordingly, less material can be used for the aft inner race portion 412, and the size of the aft inner race portion 412 can be made smaller without degrading the performance of bearing assembly 400 for the brake operation of the brake assembly 10.

A part of the forward inner race portion 411 may be located in a plane perpendicular to the rotatable axis of the rotatable part 210 and/or passing through centers of the rollable bodies 430 such that the boundary or gap formed between the forward inner race portion 411 and the aft inner race portion 412 is offset from the plane perpendicular to the rotatable axis of the rotatable part 210 and/or passing through the centers of the rollable bodies 430.

Because the reduction in the size of the aft inner race portion 412 and the center offset of the forward inner race portion 411, the overall length and/or diameter of the bearing assembly can make shorter than a conventional Conrad type bearing while maintaining the capability to withstand the high load generated by the brake operation. In addition, in split design and configuration of the inner race 410 comprising the forward inner race portion 411 and the aft inner race portion 412 described above, the bearing assembly 400 can carry more rollable bodies 430 (e.g. balls) between the split type inner race 410 and the outer race 420 in comparison to a conventional Conrad type bearing having the lower limit to the number of balls, thereby providing higher load carrying capability.

In the bearing configuration shown in FIG. 2, the aft inner race portion 412 may have more clearance to the rollable bodies 430 than the forward inner race portion 411 and/or the outer race 420 in an unloaded state. The internal radius of curvature of the concave spherical surface of the forward inner race portion 411 is shorter than the internal radius of curvature of the concave spherical surface of the aft inner race portion 412, thereby producing a first gap between the outer surface of the rollable body 430 and the concave spherical surface of the forward inner race portion 411 that is smaller than a second gap between the outer surface of the rollable body 430 and the concave spherical surface of the aft inner race portion 412. The center point of the internal radius of curvature of the concave spherical surface of the forward inner race portion 411 may also be axially and/or radially offset in space from the center point of the internal radius of curvature of the concave spherical surface of the aft inner race portion 412, thereby aligning the first gap between the outer surface of the rollable body 430 and the concave spherical surface of the forward inner race portion 411 differently than the second gap between the outer surface of the rollable body 430 and the concave spherical surface of the aft inner race portion 412 to allow for asymmetric loading and contact stress characteristics between the rollable bodies 430 and the inner surfaces of the forward inner race portion 411, the forward inner race portion 412, and the outer race 420.

Therefore, according to certain embodiments of the present disclosure, by the center offset of the forward inner race portion 411 and the aft inner race portion 412 and the difference of a first clearance between the forward inner race portion 411 and the rollable body 430 and a second clearance between the aft inner race portion 412 and the rollable body 430, the rollable bodies 430 may mainly contact the forward inner race portion 411 under no load condition to provide optimal performance of the bearing assembly 400.

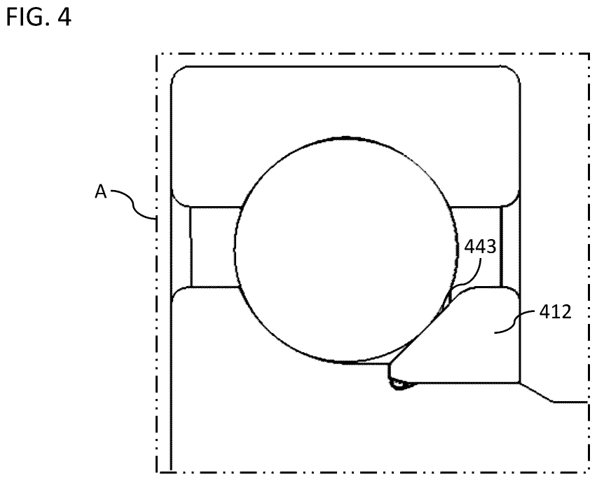

Alternatively, the inner surface of the aft inner race portion 412 facing the rollable bodies 430 may be formed as a flat surface 443 or an incline groove as illustrated in FIG. 4 for the use of simper shape configurations to reduce the manufacturing cost and simplify the process of the manufacturing the bearing assembly 400.

According to certain embodiments of the present disclosure, due to the asymmetric race profiles of the inner surfaces of the forward inner race portion 411 and the aft inner race portion 412, radial and axial load capacity in one axial direction can be achieved in the forward inner race portion 411 even though the overall size and weight of the bearing assembly 400 are reduced.

According to some embodiments of the present disclosure, a more cost effective or cheaper material and simpler design or shape configuration can be used for the aft inner race portion 412 than the forward inner race portion 411 without affecting the performance of the bearing assembly 400.

According to certain embodiments of the present disclosure, the process for ring matching requiring high cost is not needed because the aft inner race portion 412 has the only function of retaining the rollable bodies 430 and preventing the disassembly of the bearing assembly 400. While the bearing assembly 400 is being assembled, a manufacturer requires to control radial lash of the bearing assembly 400 before the aft inner race portion 412 is coupled to the bearing assembly 400. Once the aft inner race portion 412 is assembled to the bearing assembly 400, the bearing assembly 400 including the aft inner race portion 412 according to certain embodiments of the present disclosure may not reduce the radial lash within the bearing assembly 400, and therefore the ring matching process for the bearing assembly 400 according to certain embodiments of the present disclosure may not be needed. Hence, less precision production methods for the bearing assembly 400 can be used by having a split race configuration of an inner race including the forward inner race portion 411 and the aft inner race portion 412 described above.

Although the outer race 420 is illustrated as a single piece race in certain embodiments of the present disclosure, the outer race 420 may has a split race configuration such that the outer race 420 includes a forward outer race portion and an aft outer race portion. However, the forward outer race portion of the outer race 420 may be implemented with the explanation regarding the aft inner race portion 412 described above and the aft outer race portion of the outer race 420 may be implemented with the explanation about the forward inner race portion 411 described above.

Although the example embodiments have been described in detail, it should be understood that various changes, substitutions and alterations can be made herein without departing from the spirit and scope of the present disclosure as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A brake assembly comprising:
a rotatable part configured to be rotatable by an actuator;
a translatable part operably coupled with the rotatable part, the translatable part configured to be axially translatable relative to the rotatable part to move a brake pad according to rotation of the rotatable part; and
a bearing assembly configured to support the rotatable part, the bearing assembly comprising:
an inner race comprising a forward inner race portion and an aft inner race portion, wherein the aft inner race portion located farther from the brake pad than the forward inner race portion is smaller than the forward inner race portion located closer to the brake pad than the aft inner race portion;
an outer race; and
rollable bodies rollably disposed between the inner race and the outer race.

2. The brake assembly of claim 1, wherein;
the rotatable part has a protrusion outwardly protruding toward the bearing assembly to form the forward inner race portion located closer to the brake pad than the aft inner race portion such that the forward inner race portion of the inner race is integrally formed on an outside of the rotatable part as a single piece, and
the aft inner race portion located farther from the brake pad than the forward inner race portion is attached to the outside of the rotatable part.

3. The brake assembly of claim 1, wherein the forward inner race portion located closer to the brake pad than the aft inner race portion and the aft inner race portion located farther from the brake pad than the forward inner race portion are shaped asymmetrically to each other.

4. The brake assembly of claim 1, wherein a clearance between the rollable bodies and the aft inner race portion located farther from the brake pad than the forward inner race portion is greater than a clearance between the rollable bodies and the forward inner race portion located closer to the brake pad than the aft inner race portion.

5. The brake assembly of claim 1, wherein the aft inner race portion located farther from the brake pad than the forward inner race portion has more clearance to the rollable bodies than the outer race and the forward inner race portion located closer to the brake pad than the aft inner race portion.

6. The brake assembly of claim 1, wherein a part of the forward inner race portion located closer to the brake pad than the aft inner race portion is located in a plane passing through centers of the rollable bodies such that a boundary or gap between the forward inner race portion and the aft inner race portion is offset from the plane passing through the centers of the rollable bodies.

7. The brake assembly of claim 1, wherein the forward inner race portion located closer to the brake pad than the aft inner race portion has a different material from the aft inner race portion located farther from the brake pad than the forward inner race portion.

8. The brake assembly of claim 1, wherein a weight of the aft inner race portion located farther from the brake pad than the forward inner race portion is lighter than a weight of the forward inner race portion located closer to the brake pad than the aft inner race portion.

9. The brake assembly of claim 1, wherein a strength of the aft inner race portion located farther from the brake pad than the forward inner race portion is lower in strength of the forward inner race portion located closer to the brake pad than the aft inner race portion.

10. The brake assembly of claim 1, wherein an internal radius of curvature of an inner surface of the forward inner race portion, located closer to the brake pad than the aft inner race portion, facing the rollable bodies is shorter than an internal radius of curvature of an inner surface of the aft inner race portion, located farther from the brake pad than the forward inner race portion, facing the rollable bodies.

11. The brake assembly of claim 1, wherein a center point of an internal radius of curvature of an inner surface of the forward inner race portion, located closer to the brake pad than the aft inner race portion, facing the rollable bodies is offset from a center point of an internal radius of curvature of an inner surface of the aft inner race portion, located farther from the brake pad than the forward inner race portion, facing the rollable bodies.

12. The brake assembly of claim 1, wherein:
an inner surface of the forward inner race portion, located closer to the brake pad than the aft inner race portion, facing the rollable bodies is curved, and
an inner surface of the aft inner race portion, located farther from the brake pad than the forward inner race portion, facing the rollable bodies is flat.

13. The brake assembly of claim 1, further comprising a retainer configured to support the aft inner race portion, located farther from the brake pad than the forward inner race portion, to limit movement of the aft inner race portion in an axial direction of the rotation part.

14. The brake assembly of claim 13, wherein the retainer extends between a gear or pulley provided on the rotatable body and one side of the aft inner race portion located farther from the brake pad than the forward inner race portion such that the retainer supported by the gear provided on the rotatable body supports the aft inner race portion.

15. The brake assembly of claim 1, further comprising a gear or pulley provided on the rotatable body and supporting one side of the aft inner race portion located farther from the brake pad than the forward inner race portion to retain the aft inner race portion the bearing assembly.

16. The brake assembly of claim 1, wherein the aft inner race portion located farther from the brake pad than the forward inner race portion is press-fitted on the rotatable body.

17. A brake assembly comprising:
a rotatable part configured to be rotatable by an actuator;
a translatable part operably coupled with the rotatable part, the translatable part configured to be axially translatable relative to the rotatable part to move a brake pad according to rotation of the rotatable part; and
a bearing assembly configured to support the rotatable part, the bearing assembly comprising:
an inner race comprising a forward inner race portion and an aft inner race portion, wherein the forward inner race portion located closer to the brake pad than the aft inner race portion has a different material from the aft inner race portion located farther from the brake pad than the forward inner race portion;
an outer race; and
rollable bodies rollably disposed between the inner race and the outer race.

18. The brake assembly of claim 17, wherein a strength of the aft inner race portion located farther from the brake pad than the forward inner race portion is lower in strength of the forward inner race portion located closer to the brake pad than the aft inner race portion.

19. A brake assembly comprising:
a rotatable part configured to be rotatable by an actuator;
a translatable part operably coupled with the rotatable part, the translatable part configured to be axially translatable relative to the rotatable part to move a brake pad according to rotation of the rotatable part; and
a bearing assembly configured to support the rotatable part, the bearing assembly comprising:
an inner race comprising a forward inner race portion and an aft inner race portion, wherein a strength of the aft inner race portion located farther from the brake pad than the forward inner race portion is lower in strength of the forward inner race portion located closer to the brake pad than the aft inner race portion;
an outer race; and
rollable bodies rollably disposed between the inner race and the outer race.

20. The brake assembly of claim 19, wherein the aft inner race portion located farther from the brake pad than the forward inter race portion is smaller than the forward inner race portion located closer to the brake pad than the aft inner race portion.
